(19) United States
(12) Patent Application Publication
(10) Pub. No.: US 2014/0046871 A1
(43) Pub. Date: Feb. 13, 2014

(54) Longevity Retirement Protection Fund System And Method

(71) Applicant: Stuart Silverman, Manhasset Hills, NY (US)

(72) Inventor: Stuart Silverman, Manhasset Hills, NY (US)

(21) Appl. No.: 13/569,343

(22) Filed: Aug. 8, 2012

(51) Int. Cl. G06Q 40/06

(52) U.S. Cl. 705/36 R

(57) ABSTRACT

A system and method for facilitating the provisions of a longevity retirement protection fund that provides payments to fund participants based upon the participants' contributions to the fund, the projected longevity of the participants, and the investment performance of the fund. The periodic redemption amounts are based upon the amount the participant invests, upon the particular participant's projected longevity, and upon the fund's investment and longevity performance. Each participant is accordingly assured of receiving the periodic redemption amounts for the balance of the participant's life, subject to the investment and longevity experience of the fund, thereby making the longevity retirement protection fund a self-insured socializing of the longevity and mortality experiences among all of the fund members.

### BACKGROUND OF THE INVENTION

### Field of the Invention

The present invention relates generally to retirement funds that provide periodic payments to participants, and more particularly to a system and method for operating a longevity retirement protection fund that provides payments to fund participants based upon the participants' contributions to the fund, the projected longevity of the participants, and the investment performance of the fund.

While many people have accumulated funds for retirement, and even if they have accumulated a considerable amount of retirement funds, many of them still do not have adequate longevity protection, and thus run the risk of out-living their money at a point in their lives when they can least afford to do so. While individuals can purchase payout annuities from insurance companies which provide the purchaser with continuing payments with a fixed total annual amount, many avoid purchasing such payout annuities because they are often considered expensive, they are not liquid, and they have only limited investment options.

One alternative to such annuities is a tontine, which is an investment plan that was originally devised in the 17th century and that became relatively widespread in the 18th and 19th centuries. A tontine combines features of a group annuity and a lottery, with each subscriber paying an agreed-upon sum into the fund, and thereafter receiving an annuity. As members of the tontine die, their shares devolve to the other participants, and so the value of each remaining annuity increases.

Upon the death of the last member of the tontine, the tontine ends with the capital going to the organizer of the tontine (which was frequently a corporate or governmental entity, which used the proceeds of the subscription to fund private or public works projects, respectively). In a variation of this scheme, upon the death of the penultimate subscriber, the capital immediately passes to the sole surviving subscriber. While tontines were very popular in France, Britain, and the United States at one time, tontines have been banned in Britain and in many states in the United States, principally due to the unfortunate fact that many tontine arrangements turned out to be little more than swindles.

As might be expected, a number of other arrangements with similar objectives have been attempted in various diverse endeavors to provide a system of regular payments in exchange for an initial investment. For example, see U.S. Patent Application Publication No. 2012/0158612 (the “'612 Publication”) and Australian Patent Application Nos. AU2007100593 (the “'593 Application”) and AU2007100595 (the “'595 Application”), all to Robertson (collectively referred to herein as the “Robertson Applications”). The Robertson Applications each establish an investment pool from which each investor who has reached a minimum age is paid an annual “survival benefit.” If an investor dies, a portion of that investor's “notional” share of the investment pool is paid to the estate of the deceased investor, with the remainder being distributed to the “notional” accounts of the surviving investors, which creates the possibility of tontine effects. Each “notional” account has a cash surrender value (a portion of that investor's “notional” share of the investment pool) if the investor owning the account withdraws from the investment pool.

The Robertson Applications have a number of other significant disadvantages. First, the investors are not paid the annual “survival benefit” till reaching an advanced age (which in at least one embedment is the investor's predicted age of mortality). Second, the fact that the Robertson Applications pay a significant death benefit means that they are much less effective at paying living incomes during the lifetimes of the investors. Further, an annual benefit is far from optimal since most individuals interested in such a plan would need more frequent, i.e. at least monthly, disbursements. As such, the Robertson Applications are not believed to be useful for the situation contemplated herein, namely providing periodic payments to participants during their respective lifetimes while ensuring that the participants will receive such payments for their entire lifetimes by socializing the longevity and mortality experiences among all of the fund participants.

Another example of an arrangements with somewhat similar objectives is U.S. Patent Application Publication No. 2009/0287507, to van Breda et al. (the “van Breda Application”), which allows individuals to use any asset that is sufficiently marketable and does not lose its value immediately upon the death of the individual owner. Disadvantageously, the van Breda et al. Application does not provide any benefits until the individual reaches a pre-established survival age. Further, the van Breda et al. Application automatically calculates new rates of return considering available funds from those participants that have deceased, making it effectively a tontine. Further, the van Breda et al. Application specifies that during the time between the provision of the asset by an individual to the asset pool and the time at which survival benefits begin, if the individual dies the entirety of the assets provided by the individual to the pool are returned to the individual's estate.

Still another example of arrangements with like objectives may be found in U.S. Pat. No. 5,592,379, to Finfrock et al. (the “Finfrock et al. patent”) and in U.S. Patent Application Publication Nos. 2009/0271326 (the “'326 Publication”) and 2011/0231337 (the “'337 Publication”), both to Finfrock et al. (collectively referred to herein as the “Finfrock et al. Publications”). The Finfrock et al. patent discloses a method and apparatus for administering a program to senior citizens of a common age based upon contributions to the purchase of government bonds or the like. As long as each participant is alive, that participant will share equally (due to a decreasing number of remaining living participants) in the income stream derived from the interest from the security based on the participant's initial investment. While the resulting interest of the income producing bonds is distributed to the remainder of living participants, upon bond maturity the maturity value is distributed to the participants or their estates. Thus, the Finfrock et al. patent fails to manage the longevity risk beyond the termination date of the program (the bond maturity date).

The Finfrock et al. Publications disclose a retirement fund program requiring a fixed initial investment and producing a revenue stream to a group of participant investors having the same median life expectancy and grouped into an investment partnership. The fund is used to generate income for the partnership, with surviving members of the partnership being entitled to periodically receive the revenue generated from the portfolio, which increase as fewer participant investors survive. The partnership may also purchase term life insurance on each participant, so that the initial investment can be returned to the estate of a participant if the participant becomes deceased during the program. Upon termination of the program, which is for a fixed period such as the median life expectancy, the remaining assets are distributed among the living participants. Thus, the Finfrock et al. Publications also fail to manage the longevity risk beyond the termination date of the program (the bond maturity date).

It is accordingly desirable to facilitate the provision of a longevity retirement protection fund that provides payments to fund participants based upon participants' contributions to the fund, the fund investment performance, and the projected longevity of the participants.

The subject matter discussed in this background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

### SUMMARY OF THE INVENTION

The disadvantages and limitations of the background art discussed above are overcome by the present invention. With this invention, a system and related method are provided for facilitating the provision of a longevity retirement protection fund that provides payments to fund participants based upon the participants' contributions to the fund, the projected longevity of the participants, and the investment performance of the fund. While the longevity retirement protection fund system and method provides longevity protection, it avoids tontine effects. A participant investing in the longevity retirement protection fund provides an investment amount to the longevity retirement protection fund at the outset, as well as providing information that bears on the projected longevity of the participant. A redemption pattern for each participant is based primarily upon that participant's projected longevity, and the redemption pattern may be updated at regularly scheduled intervals thereafter.

Each participant's projected longevity is determined when the participant joins the fund. Projected longevity may be determined for each participant based upon a variety of factors, including, for example, age, sex, smoking status, and various medical factors that bear on the projected longevity of the participant. Redemptions that will be paid out periodically (e.g., monthly) to the participant are calculated based upon the particular participant's projected longevity, the amount the participant invests, the fund's investment performance, and the fund's longevity performance.

When a participant dies, the participant's redemptions are ended and no return of any unexpended funds is made. Thus, it will be appreciated that unredeemed funds for participants that do not live as long as their projected longevity are utilized to protect the participants that live longer than their projected longevity by supplementing their funds. In this way, the participants are all sharing in the longevity risk.

It is clear that the longevity retirement protection fund system and method of the present invention is not an insurance product, and that there are no guarantees to participants in the longevity retirement protection fund. If the mortality experience for the fund is as expected when a participant enters the fund, the participant will receive the expected redemption pattern for his or her remaining life. If the levels of mortality experienced by the fund are higher (lower) than expected when the participant entered the fund, the participant will fully participate in the mortality experience of the group and receive more (less) redemptions than the expected redemption pattern for his or her remaining life. As such, the longevity retirement protection fund system and method of the present invention may be thought of as a self-insured socializing of the longevity and mortality experiences among all of the fund members.

A participant may withdraw from the longevity retirement protection fund system and method of the present invention at any time (either in part or fully), and will receive an appropriate amount based upon the plan design. Thus, the longevity retirement protection fund system and method of the present invention has a significant degree of liquidity.

By combining functions in a novel manner and applying proprietary technology, the longevity retirement protection fund system and method of the present invention transforms a mutual fund into a vehicle that also provides a significant level of longevity protection while retaining investment flexibility. The benefits for participants in the longevity retirement protection fund will be longevity protection at a lower cost than an insured payout annuity, while preserving liquidity and investment choices. Cost savings comes from the fact that the participants in the longevity retirement protection fund are sharing the longevity risk among themselves, and thus do not need to pay for an insurer's risk and capital charges.

In a method embodiment of providing periodic financial payments to participants in a longevity retirement protection fund that provides periodic payments for the duration of the fund participants' lifetimes: a financial investment is received from each fund participant; a projected longevity is determined for each fund participant; the financial investments from the fund participants are invested; periodic redemption payments are provided to each fund participant in an amount that is based upon at least that fund participant's financial investment and the projected longevity of that fund participant; periodic redemption payments to fund participants cease to be made upon their death; and the surplus remaining from the financial investments from fund participants who die prior to the expiration of their projected longevity is used to fund the periodic redemption payments made to fund periodic redemption payments made to fund participants who live longer than their projected longevity.

In another method embodiment of providing periodic financial payments to participants in a longevity retirement protection fund that provides the periodic payments for the duration of the fund participants' lifetimes: a financial investment is received from each fund participant; a projected longevity is determined for each fund participant based upon personal, medical, and lifestyle information regarding that fund participant and actuarial information; the financial investments from the fund participants is invested in accord with investment preferences of the fund participants; the amount of the periodic redemption payments for each fund participant is calculated based upon based upon that participant's financial investment, the projected longevity of that participant, returns on that participant's financial investment, and costs imposed by an operator of the method; the periodic redemption payments are provided to each fund participant so long as that fund participant is living; information indicative of the death of fund participants is obtained to facilitate ceasing to make periodic redemption payments to fund participants upon their death; the periodic redemption payments to fund participants cease to be made upon their death; and the surplus remaining from the financial investments from fund participants who die prior to the expiration of their projected longevity are used to fund the periodic redemption payments made to fund periodic redemption payments made to fund participants who live longer than their projected longevity.

In yet another method embodiment of providing periodic financial payments to participants for the duration of the participants' lifetimes: a financial investment is received from each participant; a projected longevity for each participant is determined; the financial investments from the participants are invested; periodic redemption payments to each participant are provided in an amount that is based upon that participant's financial investment, the projected longevity of that participant, returns on that participant's financial investment, and costs imposed by an operator of the method; and periodic redemption payments to participants cease to be made upon their death.

In a system embodiment, a system for operating a longevity retirement protection fund to provide periodic financial payments to fund participants for the duration of the fund participants' lifetimes comprises: an account maintenance processor that receives a financial investment from each fund participant and maintains account information for each fund participant; a projected longevity processor that determines a projected longevity for each fund participant; an investment management processor that invests and manages the financial investments from the fund participants; a redemption payment processor that provides periodic redemption payments to each fund participant which periodic redemption payments are in an amount that is based upon at least that fund participant's financial investment and the projected longevity of that fund participant; and a participant death data processor that provides information indicative of the death of fund participants; wherein the system is arranged and configured to cease making periodic redemption payments to fund participants upon receipt of information indicative of their death; and wherein the system is also arranged and configured to using the surplus remaining from the financial investments from fund participants who die prior to the expiration of their projected longevity to fund the periodic redemption payments made to fund periodic redemption payments made to fund participants who live longer than their projected longevity.

It may therefore be seen that the longevity retirement protection fund system and method of the present invention facilitates the provision of a longevity retirement protection fund that provides payments to fund participants based upon the participants' contributions to the fund, the fund investment performance, the fund longevity performance, and the projected longevity of the participants. The periodic redemption amounts are based upon the amount the participant invests, upon the particular participant's projected longevity, and upon the fund's investment and longevity performance. Each participant is accordingly assured of receiving the periodic redemption amounts, adjusted to reflect the fund's investment and longevity performance, for the balance of the participant's life, thereby making the longevity retirement protection fund a self-insured socializing of the longevity and mortality experiences among all of the fund members. Further, the longevity retirement protection fund system and method of the present invention achieves numerous advantages without incurring any substantial relative disadvantage.

### DESCRIPTION OF THE DRAWINGS

These and other advantages of the present invention are best understood with reference to the drawings, in which:

FIG. 1 is a functional schematic diagram showing the flows of moneys and information between participants and the three main modules of the longevity retirement protection fund system and method;

FIG. 2 is a schematic block diagram showing an overview of an exemplary system that may be used to implement the longevity retirement protection fund method of the present invention;

FIG. 3 is a flowchart schematically illustrating the operation of adding a new participant to the longevity retirement protection fund system and method of the present invention;

FIG. 4 is a flowchart schematically illustrating the modification of redemptions over time to reflect investment and longevity experience by the longevity retirement protection fund system and method;

FIG. 5 is a flowchart schematically illustrating how redemptions can be modified over time to manage the total longevity retirement protection fund; and

FIG. 6 is a flowchart schematically illustrating how a participant may terminate participation in the longevity retirement protection fund system and method of the present invention.

### DETAILED DESCRIPTION OF THE PREFERRED EMBODIMENT

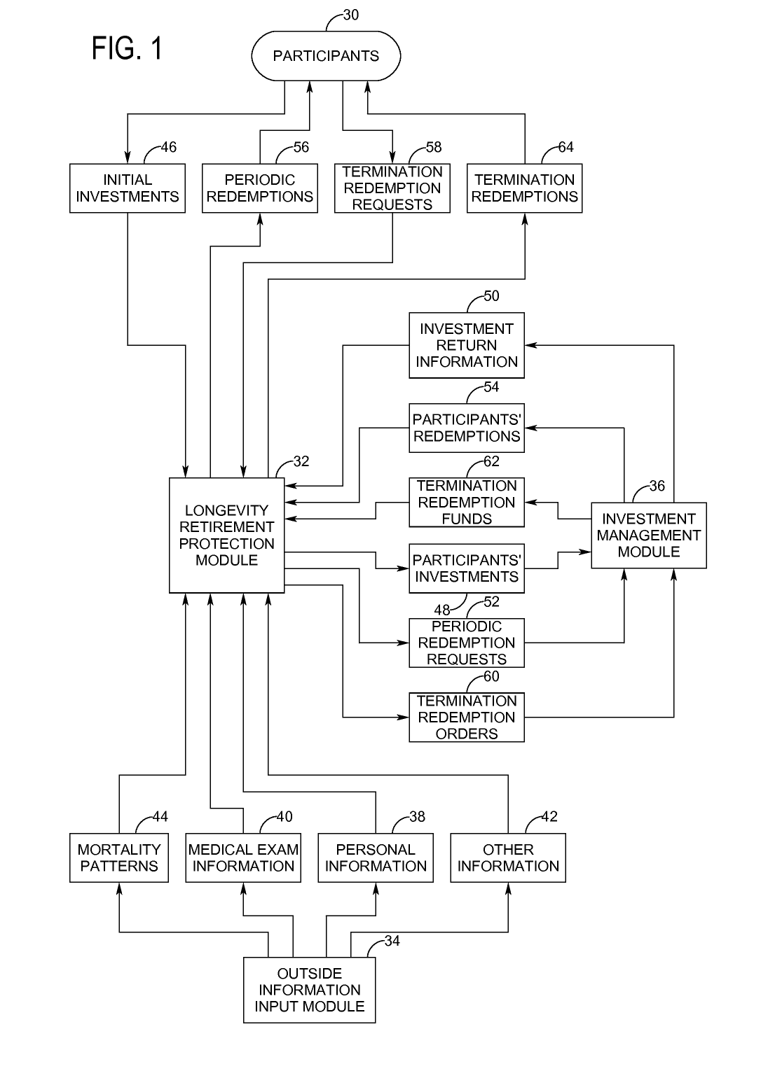

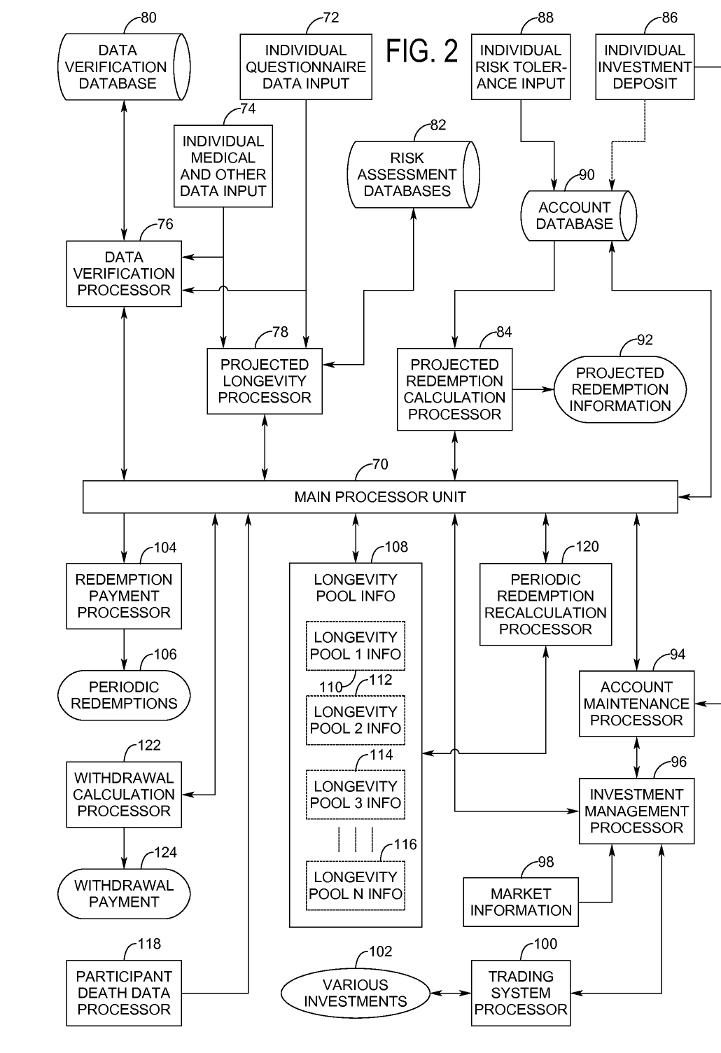

The preferred embodiment of the longevity retirement protection fund system and method of the present invention is illustrated in schematic block diagram fashion in FIG. 1, which shows the flows of moneys and information between a plurality of participants and the three main modules of the longevity retirement protection fund system and method. The participants 30 interface with a longevity retirement protection module 32, which itself interfaces with an outside information input modules 34 and an investment management module 36. It should be noted that FIG. 1 only shows the flow of moneys and information between the participants 30 and the longevity retirement protection module 32, the outside information input module 34, and the investment management module 36, while the operation of the longevity retirement protection fund system and method will be described in conjunction with FIGS. 2 through 6 below.

The outside information input modules 34 functions primarily to enable the participants 30 to be enrolled in the longevity retirement protection fund system and method of the present invention by providing relevant information regarding the participants 30 that is statistically pertinent to a determination of the estimated longevity of the participants 30 required for the longevity retirement protection fund system and method to function. The outside information input module 34 provides personal information 38 that is typically provided by the participants 30 filling out an application form. Such personal information 38 includes information identifying the participants 30, as well as information relating to medical conditions and other relevant information regarding the age, sex, personal habits (smoking, drinking, etc.), and lifestyle of the participants 30.

The outside information input module 34 optionally provides medical examination information 40 that may result from a physician examining the participants 30 to the longevity retirement protection module 32. While having such medical examination information from a physician examination is preferable in order to enable the best projection of participant longevity, it may not be preferable as far as enrolling participants into the longevity retirement protection fund. Further, other information 42 may also be provided by the outside information input module 34 to the participants 30, such as, for example, information relating to medical conditions, prescription drugs, and dangerous lifestyles (adverse driving records, hazardous sports, aviation activity, or high risk lifestyles) obtained from outside databases such as the Medical Information Bureau (“MIB”), which collects information from insurance companies and other sources. Finally, the longevity retirement protection module 32 also provides mortality pattern information 44 which is actuarial information that can use the personal information 38, the medical examination information 40, and the other information 42 to calculate the projected mortality of the participants 30.

Upon being accepted into the longevity retirement protection fund, the participants 30 provide initial investments 46 to the longevity retirement protection module 32, which tracks the participants' investments and transmits participants' investments 48 to the investment management module 36. The investment management module 36 provides investment return information 50 to the longevity retirement protection module 32.

The longevity retirement protection module 32 also calculates the periodic (typically monthly) distributions to be made by the longevity retirement protection fund system and method to the participants 30. The longevity retirement protection module 32 provides periodic redemption requests 52 to the investment management module 36, which in return provides participants' redemptions 54 to the longevity retirement protection module 32, which distributes them as periodic redemptions 56 to the participants 30.

Should one of the participants 30 elect to prematurely terminate enrollment in the longevity retirement protection fund, termination redemption requests 58 are provided by the participants 30 to the longevity retirement protection module 32, which in turn provides corresponding termination redemption orders 60 for appropriate amounts to the investment management module 36. In response, the longevity retirement protection module 32 provide termination redemption funds 62 to the longevity retirement protection module 32, which in turn provide termination redemptions 64 to the participants 30.

Referring next to FIG. 2, an exemplary embodiment of a longevity retirement protection fund system is illustrated in schematic block diagram fashion. The longevity retirement protection fund system of FIG. 2 includes a main processor unit 70 which coordinates the various other components of the longevity retirement protection fund system. A number of other components of the longevity retirement protection fund system are connected to the main processor unit 70 to provide inputs thereto or to exchange information therewith. A number of these other components are also processors, which may be implemented either as separate components or as virtual components integrated in the main processor unit 70.

A number of the components that are connected directly to the main processor unit 70 or provide information to the main processor unit 70 are components of the outside information input module 34 (shown in FIG. 1). An individual questionnaire data input 72 and an individual medical and other data input 74 provide information about applicants to a data verification processor 76, which is operatively connected to the main processor unit 70, and to a projected longevity processor 78, which is also operatively connected to the main processor unit 70. A data verification database 80 that contains data that may be used to verify the information from the individual questionnaire data input 72 and potentially the individual medical and other data input 74 also provides information to the data verification processor 76. Risk assessment databases 82 contain proprietary data that will be used by the projected longevity processor 78 to process all of the data from the individual questionnaire data input 72 and the individual medical and other data input 74 once it has been verified by the data verification processor 76 using the data verification database 80.

Together, the individual questionnaire data input 72, the individual medical and other data input 74, the data verification processor 76, the projected longevity processor 78, the data verification database 80, and the risk assessment databases 82 comprise the outside information input module 34 (shown in FIG. 1). The individual questionnaire data input 72 provides the personal information 38 (shown in FIG. 1), the individual medical and other data input 74 provides the medical examination information 40 and the other information 42 (both shown in FIG. 1), and the risk assessment databases 82 provide the mortality pattern information 44 (shown in FIG. 1).

The verified data is provided by the data verification processor 76 to the main processor unit 70, which will make a decision as to whether or not to accept the applicant. The verified data is provided by the main processor unit 70 to the projected longevity processor 78, which calculates the applicant's estimated longevity, and provides this information to the main processor unit 70 as well. The information regarding the applicant's estimated longevity will be provided by the main processor unit 70 to a projected redemption calculation processor 84 as its most important input.

Once the main processor unit 70 has determined that an applicant will be accepted into the longevity retirement protection fund, additional information will be sought from the individual regarding the amount that the individual will provide to the longevity retirement protection fund as well as information relating to the individual's investment preferences. Thus, the amount of an individual investment deposit 86 and an individual risk tolerance input 88 (or an election of the investments that a participant in the longevity retirement protection fund desires to make) are provided to an account database 90 that maintains records regarding all of the individuals having a longevity retirement protection fund account. The account database 90 is operatively connected to supply information to and receive information from the main processor unit 70.

The account database 90 also provides information regarding an applicant's individual investment deposit 86 and individual risk tolerance input 88 to the projected redemption calculation processor 84, where this information is used together with the information regarding the applicant's estimated longevity to generate projected redemption information 92. This the projected redemption information 92 is the estimated periodic amount (e.g., the monthly amount) that will be paid to the applicant, at least for an initial period (e.g., the next year). In its simplest form, the estimated redemption amount is the individual investment deposit 86 divided by the number of months left in the applicant's estimated longevity. In a more complete form, the actual or projected investment return and/or the cost of operating the longevity retirement protection fund are also factored into the determination of the projected redemption information 92. Together, the projected redemption calculation processor 84, the account database 90, and the projected redemption information 92 comprise part of the longevity retirement protection module 32 (shown in FIG. 1).

The individual investment deposit 86 itself is applied to an account maintenance processor 94, which is operatively connected to the main processor unit 70 and which maintains the accounts of each of the participants in the longevity retirement protection fund. The amounts of the participants' longevity retirement protection funds are provided by the account maintenance processor 94 to an investment management processor 96 which manages the funds in each participant's longevity retirement protection fund. Market information 98 is provided to the investment management processor 96, and the investment management processor 96 is operatively connected to a trading system processor 100, which buys and sells various investments 102 held by the participants' the longevity retirement protection funds. Together, the account maintenance processor 94, the investment management processor 96, the market information 98, the trading system processor 100, and the various investments 102 comprise the investment management module 36 (shown in FIG. 1).

The main processor unit 70 operatively controls a redemption payment processor 104 to cause it to issue periodic redemptions 106 to the longevity retirement protection fund participants.

The longevity retirement protection fund system and method of the present invention optionally may maintain information regarding more than one longevity retirement protection fund. For example, different funds may be established for different ranges of estimated participant longevity; for example, one fund could be set up for participants having from ten to fifteen years estimated longevity, another fund could be set up for participants having from fifteen to twenty years estimated longevity, yet another fund could be set up of participants having from twenty to twenty-five years estimated longevity, etc. All of these pools together could constitute a total longevity retirement protection fund pool. Alternatively, different funds could be set up according to the investment choices made by participants; for example, there could be different funds for each of a plurality of investment options, e.g. a fund for each investment type, or an investment for each of a plurality of investments having different risk levels.

FIG. 2 shows a total longevity retirement protection fund pool 108 operatively connected to the main processor unit 70. The total longevity retirement protection fund pool 108 includes a first longevity retirement protection fund pool 110, a second longevity retirement protection fund pool 112, a third longevity retirement protection fund pool 114, up to an nth longevity retirement protection fund pool 116.

Since the plan used by the longevity retirement protection fund system and method involves paying the participants a periodic (e.g., monthly) redemption for their remaining lifetimes, it is necessary to take note of participants who become deceased. A participant death data processor 118 monitors information relating to the deaths of participants, and provides such information to the main processor unit 70. Upon the death of a participant in the longevity retirement protection fund, the periodic redemptions 106 to that participant are ceased, and no further accounting for that participant or to the estate of that participant is necessary.

Since the situation encountered in operating the longevity retirement protection fund may vary over time, it may be desirable to periodically (e.g., annually) recalculate the amounts of the periodic redemptions being paid to the longevity retirement protection fund participants. Accordingly, a periodic redemption recalculation processor 120 is shown as being operatively connected to the main processor unit 70 and to the total longevity retirement protection fund pool 108. Such a periodic recalculation of the amounts of the periodic redemptions being paid to the longevity retirement protection fund participants will take into account changes in the returns on investments, the mortality of the longevity retirement protection fund system participants, and any changes to the operating cost (e.g., expense charges or profit) of the longevity retirement protection fund system.

Since it may be desirable to allow the longevity retirement protection fund participants to withdraw from the longevity retirement protection fund under certain circumstances, a withdrawal calculation processor 122 is operatively connected to the main processor unit 70 to perform such a calculation. In the preferred embodiment of the present invention, this calculation requires the performance of a newly performed estimated longevity calculation for the withdrawing participant reflecting the withdrawing participant's current medical information and the preparation of a newly calculated periodic redemption amount. The net present value of the payments of the recalculated periodic redemption amounts for the newly performed estimated participant longevity is determined, and the participant will obtain a withdrawal payment 124 of the lesser of that value or the participant's fund value at the time of withdrawal. Together, the redemption payment processor 104, the total longevity retirement protection fund pool 108, the participant death data processor 118, the periodic redemption recalculation processor 120, and the withdrawal calculation processor 122 comprise the rest of the longevity retirement protection module 32 (shown in FIG. 1).

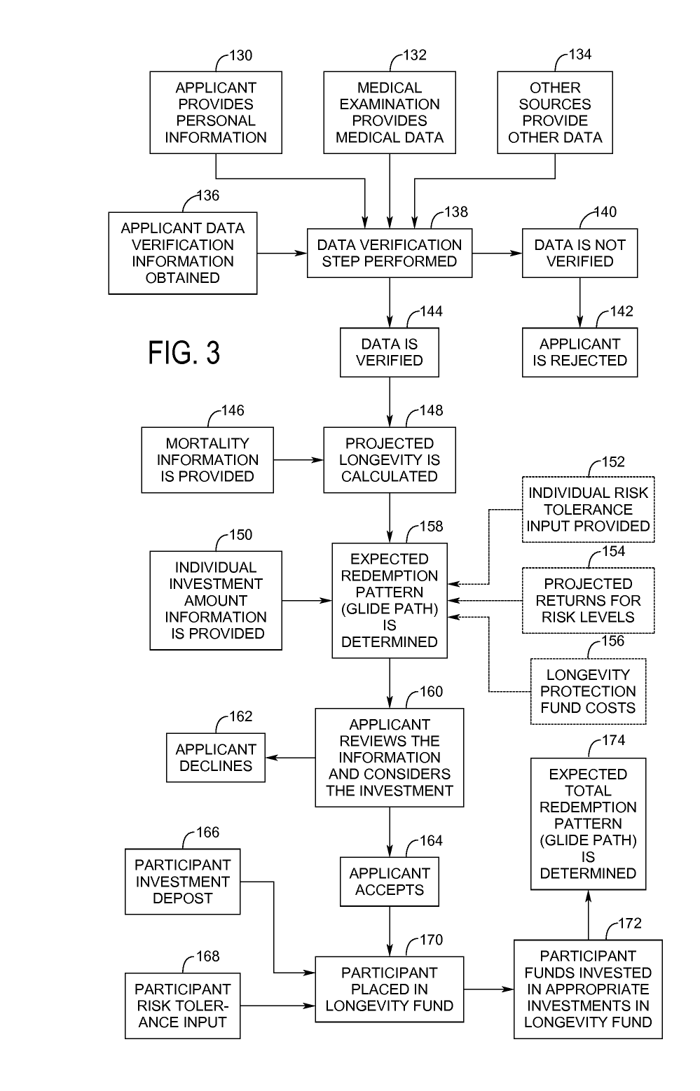

Referring now to FIG. 3, the operation of adding a new participant to the longevity retirement protection fund system and method of the present invention is illustrated. An applicant provides personal information in an applicant provides personal information step 130, typically by filling out a form similar to the type of form used to apply for life insurance. In the form, the applicant includes personal information including health and medical information. Optionally (as mentioned above), the applicant may also be required to have a medical examination in which the results are provided directly to the longevity retirement protection fund system in a medical examination provides medical data step 132. This is preferable in order to enable the best projection of participant longevity, but it may not be preferable insofar as it may reduce the enrollment of participants into the longevity retirement protection fund.

Additional information regarding the applicant is also collected by the longevity retirement protection fund system in an other sources provide other data step 134. Additional information may also be used for verification purposes, with such information being supplied in an applicant data verification information obtained step 136. Such other data information and data verification information can include, for example, information relating to medical conditions, prescription drugs, and dangerous lifestyles (adverse driving records, hazardous sports, aviation activity, or high risk lifestyles) obtained from outside databases such as the Medical Information Bureau (“MIB”), which collects information from insurance companies and other sources.

Using all of this information, the longevity retirement protection fund system verifies the data in a data verification step 138. If it is determined that the data is not verified in a data is not verified step 140 (generally indicative of the submission of fraudulent information by the applicant), the applicant is rejected for inclusion in the longevity retirement protection fund in an applicant is rejected step 142. If, on the other hand, the data is verified in a data is verified step 144, the applicant is informed that he/she will be accepted.

The process next moves to a determination of the estimated longevity for the applicant. Mortality information, which is typically located in a database, is provided in a mortality information is provided step 146. Using this mortality information, the applicant's projected longevity is estimated in a projected longevity is calculated step 148.

In an alternative embodiment of the longevity retirement protection fund system and method of the present invention, the longevity retirement protection fund may be based on the life expectancies of two individuals rather than that of a single individual (for example a husband and a wife). In this embodiment, the longevity retirement protection fund will make periodic payments after a first one of the two individuals dies, with the payments continuing until the survivor dies. (Optionally, the payments may initially be made to a first one of the two individuals, and if that individual dies first, the payments may then be made to the second individual.) In this joint participant embodiment, the longevity retirement protection fund system and method will calculate the projected longevity of both individuals and then calculate a composite projected longevity, which will be a certain amount longer than the longer of the two projected individual longevities. Another option in the joint participant longevity retirement protection fund would be to have a reduced payment (e.g., two-thirds of the initial redemption payments) after the first participant dies, since the living expenses of the second participant would be reduced when compared to the living expenses of both joint participants.

Also optionally, if desired, the joint participant longevity retirement protection fund may instead be for the life of the first to die, plus for a fixed number of years thereafter, instead of being for the life of the survivor. Optionally, the participant(s) of the longevity retirement protection fund may elect to receive redemption payments for a minimum term irrespective of whether the participant(s) die before the expiration of the minimum term. It will be appreciated by those skilled in the art that these optional alternative redemption patterns would all result in reduced redemption payments relative to the single participant life expectancy-based longevity retirement protection fund redemption pattern.

In order to estimate the expected redemption pattern, the applicant must indicate the amount of money that the applicant will invest in the longevity retirement protection fund in an individual investment amount information is provided step 150. In the most basic form of the longevity retirement protection fund system and method of the present invention, the applicant's projected longevity and the amount of money that the applicant will invest in the longevity retirement protection fund are used to determine the expected redemption pattern for the applicant, referred to as the applicant's “Glide Path.”

Preferably (and more practically), the income to the longevity retirement protection fund and the costs of operating the longevity retirement protection fund should also be taken into account. The potential income will vary according to the risk that the applicant is willing to accept, and this is provided in an individual risk tolerance input provided step 152. The expected returns for different types of investments can be provided in a projected returns for risk levels step 154. Further, the estimated costs of operating the longevity retirement protection fund system can be provided in a longevity protection fund costs step 156.

The initial Glide Path at the time the applicant deposits funds in the longevity retirement protection fund (thereby becoming a participant) will be determined in an expected redemption pattern is determined step 158 such that the actuarial present value of the stream of expected redemptions (after reflecting the returns on the longevity retirement protection fund investments and the expenses of operating the longevity retirement protection fund) will equal the initial investment. In other words, the initial investment, which will grow with the returns on investment and be reduced by the periodic redemptions and the expenses, will stay positive until it is exhausted at the end of the applicant's expected lifetime. In most instances, the expected redemptions are to be paid on a monthly basis, although other periods (twice monthly, weekly, etc.) could be used instead.

Next, the applicant will decide whether or not to invest in the longevity retirement protection fund in an applicant reviews the information and considers the investment step 160. If the applicant elects not to join the longevity retirement protection fund and declines in an applicant declines step 162, the process is terminated. On the other hand, if the applicant elects to join the longevity retirement protection fund (and become a participant) in an applicant accepts step 164, the process continues.

The new participant provides the investment amount in a participant investment deposit step 166, and provides information as to the acceptable investment risk in a participant risk tolerance input 168. The participant risk tolerance input 168 may consist of the participant choosing the investments for the participant's investment. At this point, the participant joins the longevity retirement protection fund in a participant placed in longevity retirement protection fund step 170, and the participant's investment funds are invested as dictated by the participant's risk tolerance or choice of investments in a participant finds invested in appropriate investments in the longevity retirement protection fund step 172. Optionally, the longevity retirement protection fund system and method could enter into transactions with other entities (e.g., to acquire longevity protection from an insurance company) if it is believed that doing so could benefit the longevity retirement protection fund participants.

The Glide Path of each participant is then added to the other participant's Glide Paths to produce to a total longevity retirement protection fund Glide Path in an expected total redemption pattern is determined step 174. The total longevity retirement protection fund Glide Path will be managed to ensure equitable and fair redemptions to all participants. The total longevity retirement protection fund Glide Path is the expected total funds expected redemption pattern in the longevity retirement protection fund at any point in time. The objective is to manage redemptions to avoid a tontine and as such that total funds in the longevity retirement protection fund do not stray too far from the total longevity retirement protection fund Glide Path, which may require modifying the Glide Path from time to time.

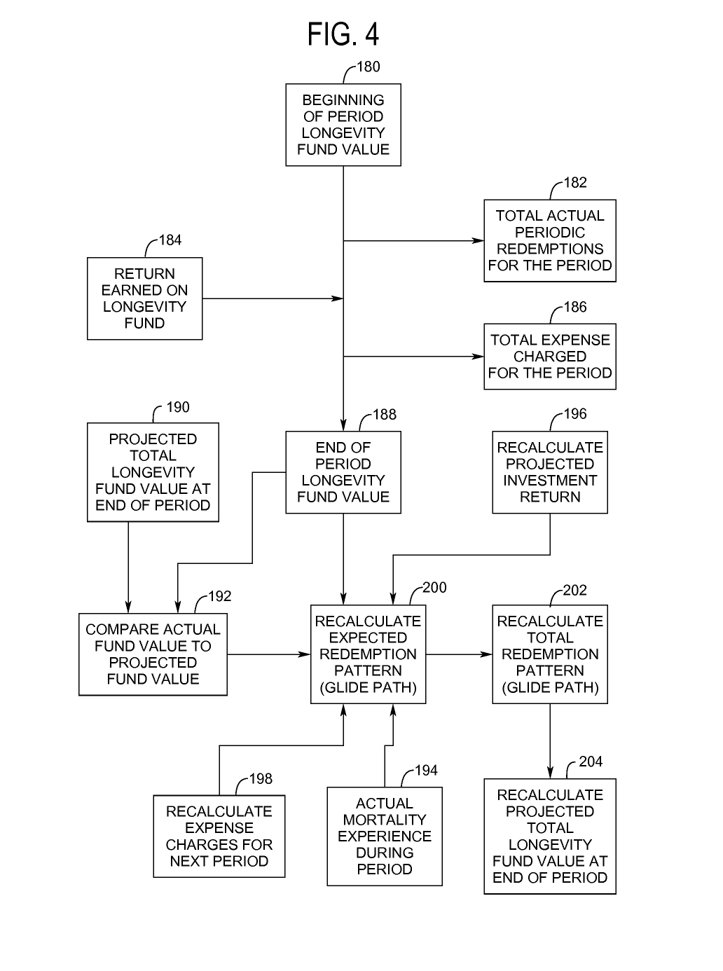

Referring next to FIG. 4, the operation of the longevity retirement protection fund over a period of time (which is typically and will be in this example one year) is illustrated. The longevity retirement protection fund has an initial value at the outset, as indicated in a beginning of period longevity retirement protection fund value 180. During this one-year period, periodic (e.g., monthly) redemptions will be paid to each participant (unless and until any participant dies during the period) as indicated by a total actual periodic redemptions for the period 182.

Also during this one-year period, the longevity retirement protection fund investments will earn a return (which may be positive or potentially negative), as indicated by the return earned on the longevity retirement protection fund 184. Additionally during this one-year period, the longevity retirement protection fund system will incur and charge expenses for operating the longevity retirement protection fund as indicated in a total expense charged for the period 186. Thus, at the end of the one-year period, the value of the longevity retirement protection fund will be the beginning of period longevity retirement protection fund value 180, plus the return earned by the longevity retirement protection fund 184, less the total actual periodic redemptions for the period 182, less the total expense charged for the period 186, as indicated in an end of period longevity retirement protection fund value step 188.

The estimate of what the total value of the longevity retirement protection fund should have been at the end of the period, as indicated in a projected total longevity retirement protection fund value at end of period step 190 (which would have been determined at the outset of the period based upon the starting value and the estimates for income, redemptions, and expenses) may be compared with the actual longevity retirement protection fund from the end of period longevity retirement protection fund value step 188 in a compare actual longevity retirement protection fund value to projected longevity retirement protection fund value step 192. Since the longevity retirement protection fund expense charges and fees should be non-variable, there are two reasons why the longevity retirement protection fund value may not match the longevity retirement protection fund Glide Path: 1. the returns on investments earned in the longevity retirement protection fund were different than it was anticipated to be in the longevity retirement protection fund Glide Path; and 2. the periodic redemptions were different than they were anticipated to be in the longevity retirement protection fund Glide Path. Since there are no guarantees in the longevity retirement protection fund and the participants fully share in the experience of the longevity retirement protection fund, the difference in interest earned and redemptions will result in changes to future redemptions and the Glide Paths.

The actual mortality history of participants is determined in an actual mortality experience during period step 194. Based upon differences in the previous estimation of the returns on investments earned in the longevity retirement protection fund and the prognosis for future returns on investments earned in the longevity retirement protection fund (which are anticipated and which will accordingly virtually always be present), the returns on the investments in the longevity retirement protection fund for the next period (e.g., the next year) are estimated in a recalculate projected investment return step 196. Additionally, the expenses and fees for operating the longevity retirement protection fund for the next period are estimated in a recalculate expense charges for the next period step 198. Although it is not shown, the longevity retirement protection fund system and method of the present invention could also optionally (but not preferably) require participants to periodically (likely not more frequently than once every five years) obtain a medical examination for use in reevaluating the potential impact of the participant's glide path on the longevity retirement protection fund.

Based upon the data provided by the end of period longevity retirement protection fund value step 188, the compare actual longevity retirement protection fund value to projected longevity retirement protection fund value step 192, the actual mortality experience during period step 194, the recalculate projected investment return step 196, and the recalculate expense charges for the next period step 198, the expected redemption pattern (Glide Path) for each participant for the next period is calculated in a recalculate expected redemption pattern step 200. Each of these expected Glide Paths are summed to produce an expected longevity retirement protection fund total Glide Path in a recalculate total redemption pattern step 202. Finally, the estimated value of the longevity retirement protection fund at the end of the period is estimated in a recalculate projected total longevity retirement protection fund value at end of period step 204.

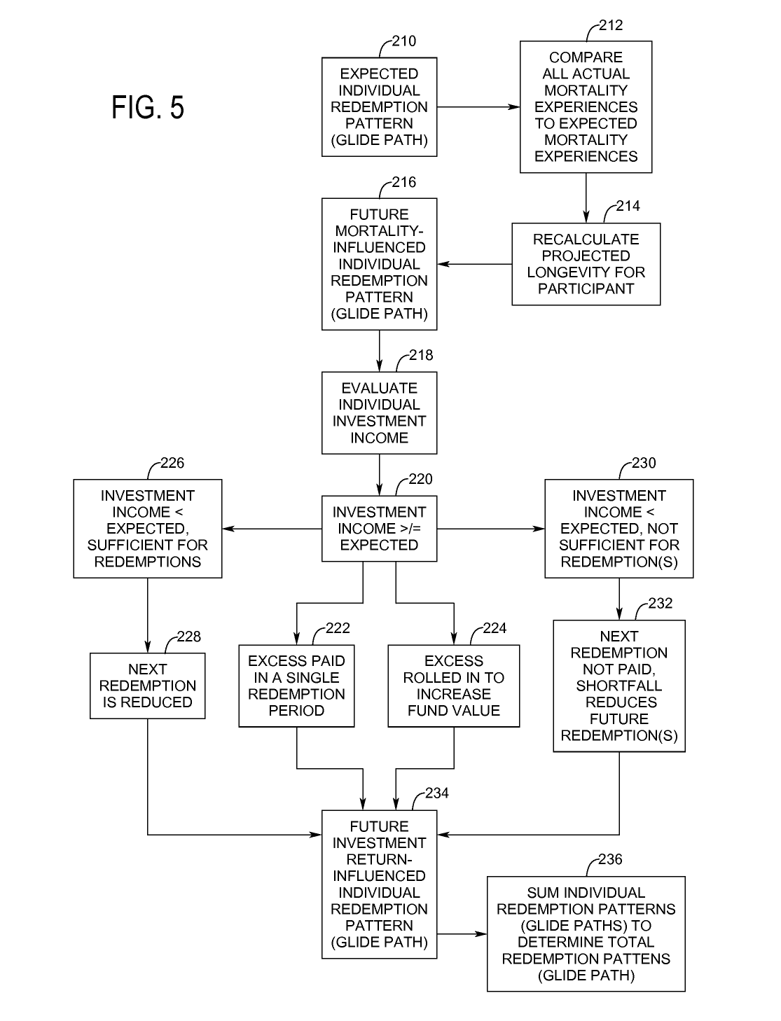

Referring now to FIG. 5, a manner in which redemptions can be modified over time to manage the total longevity retirement protection fund is illustrated. This is essentially a more complex version of the recalculate expected redemption pattern step 200 illustrated in FIG. 4. The analysis performed in FIG. 5 begins with the expected individual redemption pattern step 210, by which an estimated redemption pattern or Glide Path for a participant has been established. The difference between the actual mortality experience for all of the participants in the longevity retirement protection fund is compared with the estimated mortality experience for all of the participants in the longevity retirement protection fund in a compare all actual mortality experiences to expected mortality experiences step 212.

The historical mortality gains and losses, as well as observed patterns therein, are analyzed to determine an alternative future mortality expectation and develop a revised mortality assumption, which is then used to determine a modified estimated longevity for each participant in a recalculate projected longevity for participant step 214. The result of this analysis is a modified Glide Path for each individual participant, which is determined in a determine future mortality-influenced individual redemption pattern step 216. Future expected redemptions and the resulting modified Glide Path are solved at this point with the assumption such that it will continue to grow with interest as previously calculated and be reduced by redemptions and expenses as previously calculated, and will stay positive until it is exhausted at the end of the participant's revised expected lifetime. Note that after reviewing mortality experience (and the statistical credibility of the experience), it may be determined that no adjustment is necessary.

Next, the actual participant investment income for the past period is compared to the expected investment income used in the calculations for the participant's Glide Path during the past period in an evaluate individual investment income step 218. Depending upon the result of the evaluate individual investment income step 218, a determination is made in an investment comparison step 220 depending both upon whether or not the actual investment income was greater than or equal to the expected investment income or not. If the actual investment income was in fact greater than or equal to the expected investment income, the excess can either be paid in the next redemption period as indicated in an excess paid to the participant in a single redemption period step 222, or the excess can instead be rolled over into the participant's investments to increase them (and thus to increase the participant's Glide Patent and future redemptions after the current period) in an excess rolled in to increase fund value step 224.

Alternatively, the excess could be partially paid to the participant in the next redemption period, with the balance rolled over into the participant's investments to increase them. Another alternative would be to have the excess, or part of it, paid to the participant in equal amounts in each of a plurality of the next redemption periods, or in equal amounts in all of the redemption periods in the next year, for example.

On the other hand, if the actual investment income was in fact less than the expected investment income, there are also multiple alternatives. If the actual investment income, while being less than the expected investment income, is sufficient for future redemptions as indicated in an investment income less than expected but sufficient for redemption step 226, the next redemption is reduced by the amount of the shortfall, as indicated in a next redemption is reduced step 228. Alternatively, a plurality of the next several redemption periods could be reduced in equal amounts to make up the shortfall, or all of the redemption periods in the next year could be reduced in equal amounts to make up the shortfall. In these cases, interest on the shortfall would also be charged against the participant's future redemptions.

If the actual investment income, was both less than the expected investment income and insufficient for the next redemption(s) as indicated in an investment income less than expected and insufficient for redemption step 230, the next redemption(s) may not be paid, as indicated in a next redemption(s) not paid/shortfall reduces future redemptions step 232. If the next redemption is not paid and there is still a shortfall, the successive redemption(s) may be reduced until the shortfall is made up. Alternatively, a plurality of the next several redemption periods could instead be reduced in equal amounts to make up the shortfall, or all of the redemption periods in the next year could instead be reduced in equal amounts to make up the shortfall. In all of these cases as well, interest on the shortfall would also be charged against the participant's future redemptions.

Following any of the excess paid in a single redemption period step 222, the excess rolled in to increase fund value step 224, the next redemption is reduced step 228, or the next redemption(s) not paid/shortfall reduces future redemptions step 232, the participant's future redemptions and Glide Patent will be revised to take account of variances in the investment experience in a future investment return-influenced redemption pattern step 234. Given the revised mortality and investment assumptions, the individual participant redemption patterns and Glide Paths will thus be reset at the end of each period. Future expected redemptions and a resulting modified Glide Path will be solved for each participant such that each participant's account will grow with interest and be reduced by redemptions and expenses, and will stay positive until it is exhausted at the end of the participant's revised expected lifetime. The total longevity retirement protection fund Glide Path will be determined by summing all of the participants' Glide Paths, as indicated in a sum individual redemption patterns to determine total redemption patterns step 236.

Thus, each participant will participate in his/her own investment experience through higher or lower redemption payments. In the unlikely event that a participant dies with a shortfall associated with his/her account, that would indicate that the participant did not fully participate in the investment loss, and in most cases the shortfall would be absorbed by the remaining participants. An alternative scenario could be where all the participants invest in the same fund and fully participate in the fund investment experience (without a need to differentiate investment returns for each participant).

Assets that survive participants who have died (i.e., where the fund value is still positive when the participant dies) could be invested in a separate account for the benefit of making redemption payments to remaining living participants. These remaining assets would be invested in a manner to mitigate volatility and as closely as possible would match the expected investment rate implied in the total Glide Path. The expected investment return implied in the total Glide Path could be determined by the asset strategy of the fund, or possibly by the yield curve of low risk assets (e.g., U.S. Treasury bonds), as well as the duration of the expected redemption patterns. The expected investment return may also be modified to reflect changing economic conditions. Alternatively, these assets could instead immediately be added in as equitable a fashion as possible to each of the other participants' accounts. Another possibility would be to use these assets to offset the expenses of operating the longevity retirement protection fund.

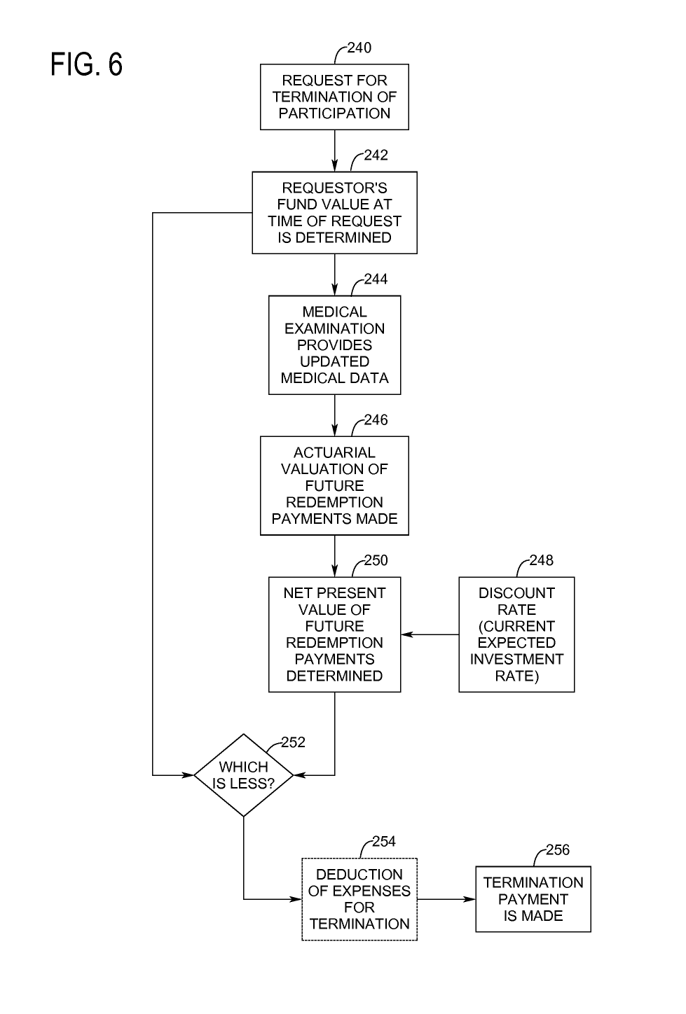

Referring next to FIG. 6, an example illustrating how a participant may terminate participation in the longevity retirement protection fund system and method of the present invention is provided. In order to protect the remaining participants, a withdrawal from the longevity retirement protection fund will be allowed but such a withdrawal will be subject to an actuarial valuation of the future redemption payments based on medical underwriting. Consider the case where the longevity retirement protection fund's expected remaining lifetime for a participant (without knowing the participant's current specific medical condition) is ten years, but the participant has a fatal disease and will die in less than one year. It is apparent that allowing the participant to withdraw his/her remaining funds would be unfair to the remaining participants.

Such a withdrawal from the longevity retirement protection fund begins with a request for termination of participation step 240. Following such a request, the value of the participant's remaining funds in the longevity retirement protection fund at the time of the request are determined in a requestor's fund value determination step 242. Next, the requestor is required to take a medical examination to provide a current understanding of the requestor's health in a medical examination provides updated medical data step 244. Using the medical information provided by the physician examining the participant and old age underwriting techniques to determine a revised mortality assumption, a new actuarial valuation of the expected redemption payments under the participant's Glide Path is made in an actuarial valuation of future redemption payments made step 246.

Next, the current discount rate (the current expected investment income rate) is obtained in a discount rate determination step 248, and is applied to the participant's revised Glide Path to determine the net present value of the participant's future redemption payments on the participant's revised Glide Path in a net present value of future redemption payments determination step 250. A preliminary termination payment may then be determined to be the lesser of the value of the participant's remaining funds in the longevity retirement protection fund at the time of the request and the net present value of the participant's future redemption payments on the participant's revised Glide Path in a lesser determination step 252. (Alternatively, the preliminary termination payment may not be floored at the value of the participant's remaining funds.) Optionally, this preliminary termination payment may be reduced by the expenses of the medical underwriting in a deduction of expenses for termination step 254, resulting in a final termination payment which is made to the now ex-participant in a termination payment step 256.

In an optional aspect of the longevity retirement protection fund system and method of the present invention, excess redemptions could be allowed in the longevity retirement protection fund to provide access to liquidity. However, to protect the other participants, there would be limitations on such excess redemptions. The remaining value of expected future redemptions would be determined assuming no excess redemptions, which will be an upper limit on the amount of the excess redemption. Optionally, another upper limit on the amount of such excess redemptions would be the actual funds allocated to the participant's account. In addition, a charge would be assessed (and future redemptions would be adjusted) to account for the excess redemption request. The excess redemption would require the participant to provide information (including medical records) relating to his or her health status. Future expected redemptions would be modified to reflect such an excess redemption. Excess redemption requirements and procedures of the longevity retirement protection fund would be communicated to an applicant to the longevity retirement protection fund inception prior to the applicant becoming a participant so that the applicant would understand how such excess redemptions would be determined.

It may therefore be appreciated from the above detailed description of the preferred embodiment of the present invention that it provides payments to fund participants based upon the participants' contributions to the fund, the fund investment performance, and the projected longevity of the participants. The periodic redemption amounts are based upon the amount the participant invests, upon the particular participant's projected longevity, and upon the fund's investment and longevity performance. Each participant is accordingly assured of receiving the periodic redemption amounts for the balance of the participant's life, subject to the investment and longevity experience of the fund, thereby making the longevity retirement protection fund a self-insured socializing of the longevity and mortality experiences among all of the fund members. Further, the longevity retirement protection fund system and method of the present invention achieves numerous advantages without incurring any substantial relative disadvantage.

Although the foregoing description of the longevity retirement protection fund system and method of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A method of providing periodic financial payments to participants in a longevity retirement protection fund that provides periodic payments for the duration of the fund participants' lifetimes, the method comprising:
receiving a financial investment from each fund participant and associating such financial investment with an account for such financial participant with an account maintenance processor;
determining a projected longevity for each fund participant with a projected longevity processor;
investing the financial investments from the fund participants with an investment management processor;
providing periodic redemption payments with a redemption payment processor to each fund participant in an amount that is based upon at least that fund participant's financial investment and the projected longevity of that fund participant;
ceasing to make the periodic redemption payments to fund participants upon their death; and
using a surplus remaining from the financial investments from fund participants who die prior to the expiration of their projected longevity to fund the periodic redemption payments made to fund participants who live longer than their projected longevity.

2. A method as defined in claim 1, wherein the determining a projected longevity step comprises:
collecting data regarding the fund participants that is statistically pertinent to the longevity of the fund participants and providing it to the projected longevity processor; and
based upon the data, estimating the longevity for each of the fund participants with the projected longevity processor.

3. A method as defined in claim 2, wherein the collecting data step comprises at least one of the steps selected from the group consisting of:
obtaining personal information from an applicant desiring to become a participant in the fund and providing it to the projected longevity processor;
optionally performing a medical examination on the applicant desiring to become a participant in the fund to obtain medical exam information and providing it to the projected longevity processor;
obtaining other information relating to medical conditions, prescription drugs, dangerous lifestyles, and/or high risk lifestyles of the applicant desiring to become a participant in the fund and providing it to the projected longevity processor; and
obtaining actuarial information that can use the personal information, the medical examination information (if obtained), and the other information and providing it to the projected longevity processor to calculate the projected mortality of the applicant desiring to become a participant in the fund.

4. A method as defined in claim 2, wherein the determining a projected longevity step additionally comprises:
verifying at least some of the data regarding the fund participants that is statistically pertinent to the longevity of the fund participants with a data verification processor.

5. A method as defined in claim 1, wherein the investing step comprises:
obtaining information from each fund participant either as to the level of risk that that fund participant is willing to accept in the financial investments of that fund participant, or the particular investments that that fund participant desires to make in the financial investments of that fund participant, and providing it to the investment management processor; and
in the investing step, investing the fund participant's financial investment according to the information obtained from that fund participant with the investment management processor.

6. A method as defined in claim 1, wherein the providing step additionally comprises:
basing the amount of the periodic redemption payments to be made by the redemption payment processor to each fund participant upon projected or actual investment performance for investments made for that fund participant in the investing step in addition to basing the amount of the periodic redemption payments to that fund participant upon that fund participant's financial investment and the projected longevity of that fund participant.

7. A method as defined in claim 6, wherein the providing step additionally comprises:
basing the amount of the periodic redemption payments to be made by the redemption payment processor to each fund participant upon a cost of operating the longevity retirement protection fund for that applicant in addition to basing the amount of the periodic redemption payments to that fund participant upon that fund participant's financial investment, the projected longevity of that fund participant, and projected or actual investment performance for investments made for that fund participant in the investing step.

8. A method as defined in claim 1, additionally comprising:
obtaining information indicative of the death of fund participants using a participant death data processor to facilitate ceasing to make periodic redemption payments by the redemption payment processor to fund participants upon their death.

9. A method as defined in claim 1, additionally comprising:
at the end of a defined period occurring less frequently than the frequency of the periodic redemption payments, recalculating the amount of the periodic redemption payments to be made to each fund participant with a periodic redemption recalculation processor by:
from the amount in the longevity retirement protection fund for that fund participant at the beginning of a defined period, adding the investment gains for that fund participant of that defined period, and subtracting the periodic redemption payments made to that fund participant during that defined period as well as costs of operating the longevity retirement protection fund to produce an end of period longevity retirement protection fund value for that participant; and
based upon that fund participant's projected longevity and estimates for investment gains for that fund participant of an upcoming defined period and costs of operating the longevity retirement protection fund during the upcoming period, calculating the periodic redemption payments to be made to that fund participant during the upcoming defined period.

10. A method as defined in claim 9, wherein the periodic redemption payments are made by the redemption payment processor monthly and the defined period is annually.

11. A method as defined in claim 1, additionally comprising:
periodically recalculating the amount of the periodic redemption payments to be made to each fund participant with a periodic redemption recalculation processor by:
comparing actual mortality experiences for all fund participants with an estimated mortality experience assumption for all fund participants;
developing a revised estimated mortality experience assumption; and
determining a modified projected longevity for each fund participant.

12. A method as defined in claim 1, additionally comprising:
periodically comparing investment income for each fund participant to an expected investment income for that fund participant;
if the investment income for that fund participant is greater than expected, either a. paying an excess with the next periodic redemption payment for that fund participant, or b. rolling over the excess into that fund participant's financial investment to increase it (and thus to increase that fund participant's future periodic redemption payments), or c. paying the excess to that fund participant in equal amounts in each of a plurality of that fund participant's next periodic redemption payments, or d. paying the excess to that fund participant in equal amounts in all of that fund participant's next periodic redemption payments in the period until a next investment income comparison;
if the investment income for that fund participant is less than expected but sufficient for future periodic redemption payments to that fund participant, reducing the next periodic redemption payments for that fund participant by the amount of the shortfall; or
if the investment income for that fund participant is less than expected and insufficient for at least one future periodic redemption payment to that fund participant, either reducing a plurality of the next several future periodic redemption payments to that fund participant in equal amounts to make up the shortfall, or reducing all of that fund participant's next periodic redemption payments in the period until a next investment income comparison in equal amounts to make up the shortfall.

13. A method as defined in claim 1, additionally comprising:
receiving a request from a fund participant to terminate participation in the longevity retirement protection fund;
determining the value of that fund participant's remaining funds in the longevity retirement protection fund at the time of the termination request;
determining a revised projected longevity for that fund participant;
determining the net present value of future periodic redemption payments for that fund participant for the revised projected longevity for that fund participant; and
determining the lesser of the value of that fund participant's remaining funds in the longevity retirement protection fund at the time of the termination request and the net present value of future periodic redemption payments for that fund participant for the revised projected longevity for that fund participant as the termination payment for that fund participant.

14. A method as defined in claim 13, wherein the determining the revised projected longevity step comprises performing a medical examination on the fund participant; and
wherein the termination payment for that fund participant is reduced by the expenses incurred in processing the termination request, including the costs of the medical examination.

15. A method as defined in claim 1, additionally comprising:
receiving a request from a fund participant to terminate participation in the longevity retirement protection fund;
optionally determining the value of that fund participant's remaining funds in the longevity retirement protection fund at the time of the termination request;
determining a revised projected longevity for that fund participant;
determining the net present value of future periodic redemption payments for that fund participant for the revised projected longevity for that fund participant; and
determining a termination payment for that fund participant based at least in part on the net present value of future periodic redemption payments for that fund participant for the revised projected longevity for that fund participant.

16. A method as defined in claim 1, wherein each fund participant may have a co-participant, wherein the method additionally comprises:
determining a projected longevity for each fund co-participant;
determining a composite projected longevity for each fund participant and that fund participant's co-participant;
wherein the providing step instead comprises providing periodic redemption payments to each fund participant and/or that participant's co-participant in an amount that is based upon at least that fund participant's financial investment and the composite projected longevity of that fund participant and that fund participant's co-participant;
wherein the ceasing step instead comprises ceasing to make periodic payments to fund participants and/or their respective co-participants upon the death of the later of them to die; and
wherein the using step instead comprises using the surplus remaining from the financial investments from fund participants and their respective co-participants who die prior to the expiration of their composite projected longevity to fund the periodic redemption payments made to fund periodic redemption payments made to fund participants and their respective co-participants who live longer than their composite projected longevity.

17. A method as defined in claim 16, additionally comprising:
establishing a minimum term during which periodic payments would be made irrespective of whether or not fund participants and their respective co-participants die prior to the minimum term;
wherein the providing step additionally comprises providing the periodic redemption payments to a named survivor of each fund participant and/or that participant's co-participant if both the fund participant and that participant's co-participant die prior to the expiration of the minimum term; and
wherein the ceasing step additionally comprises ceasing to make periodic payments to the named survivor of each fund participants and/or their respective co-participants upon the expiration of the minimum term.

18. A method as defined in claim 16, additionally comprising:
reducing the periodic redemption payments made to a surviving one of a fund participant or that fund participant's co-participant following the death of a first one of either the fund participant or that fund participant's co-participant.

19. A method as defined in claim 1, wherein each fund participant may have a co-participant, wherein the method additionally comprises:
determining a projected longevity for each fund co-participant;
determining a composite projected longevity for each fund participant and that fund participant's co-participant;
wherein the providing step instead comprises providing periodic redemption payments to each fund participant and/or that participant's co-participant in an amount that is based upon at least that fund participant's financial investment and the composite projected longevity of that fund participant and that fund participant's co-participant;
wherein the ceasing step instead comprises ceasing to make periodic payments to fund participants and/or their respective co-participants a fixed period after the death of the first of each fund participant and that fund participant's co-participant to die; and
wherein the using step instead comprises using the surplus remaining from the financial investments from fund participants and their respective co-participants who die prior to the expiration of their projected longevities to fund the periodic redemption payments made to fund periodic redemption payments made to fund participants and their respective co-participants who live longer than their projected longevities.

20. A method of providing periodic financial payments to participants in a longevity retirement protection fund that provides the periodic payments for the duration of the fund participants' lifetimes, the method comprising:
receiving a financial investment from each fund participant and associating such financial investment with an account for such financial participant with an account maintenance processor;
determining a projected longevity with a projected longevity processor for each fund participant based upon personal, medical, and lifestyle information regarding that fund participant and actuarial information;
investing the financial investments from the fund participants with an investment management processor in accord with investment preferences of the fund participants;
calculating the amount of the periodic redemption payments for each fund participant based upon based upon that participant's financial investment, the projected longevity of that participant, returns on that participant's financial investment, and costs imposed by an operator of the method;
providing the periodic redemption payments with a redemption payment processor to each fund participant so long as that fund participant is living;
obtaining information indicative of the death of fund participants to facilitate ceasing to make periodic redemption payments to fund participants upon their death;
ceasing to make the periodic redemption payments to fund participants upon their death; and
using a surplus remaining from the financial investments from fund participants who die prior to the expiration of their projected longevity to fund the periodic redemption payments made to fund participants who live longer than their projected longevity.

21. A method of providing periodic financial payments to participants for the duration of the participants' lifetimes, the method comprising:
receiving a financial investment from each participant and maintaining an account for such financial participant with an account maintenance processor;
determining a projected longevity for each participant with a projected longevity processor;
investing the financial investments from the participants with an investment management processor;
providing periodic redemption payments with a redemption payment processor to each participant in an amount that is based upon that participant's financial investment, the projected longevity of that participant, returns on that participant's financial investment, and costs imposed by an operator of the method; and
ceasing to make the periodic redemption payments to participants upon their death.

22. A system for operating a longevity retirement protection fund to provide periodic financial payments to fund participants for the duration of the fund participants' lifetimes, comprising:
an account maintenance processor that receives a financial investment from each fund participant and maintains account information for each fund participant;
a projected longevity processor that determines a projected longevity for each fund participant;
an investment management processor that invests and manages the financial investments from the fund participants;
a redemption payment processor that provides periodic redemption payments to each fund participant which periodic redemption payments are in an amount that is based upon at least that fund participant's financial investment and the projected longevity of that fund participant; and
a participant death data processor that provides information indicative of the death of fund participants;
wherein the system is arranged and configured to cease making the periodic redemption payments to fund participants upon receipt of information indicative of their death; and
wherein the system is also arranged and configured to use a surplus remaining from the financial investments from fund participants who die prior to the expiration of their projected longevity to fund the periodic redemption payments made to fund participants who live longer than their projected longevity.

23. A system as defined in claim 22, wherein the projected longevity processor has as inputs:
data regarding the fund participants that is statistically pertinent to the longevity of the fund participants; and
a risk assessment database that can use the data regarding the fund participants that is statistically pertinent to the longevity of the fund participants to calculate the projected mortality of each of the fund participants.

24. A system as defined in claim 23, wherein the data regarding the fund participants that is statistically pertinent to the longevity of the fund participants comprises:
individual questionnaire data provided by each of the fund participants;
medical exam information provided for each of the fund participants; and
information relating to medical conditions, prescription drugs, dangerous lifestyles, and/or high risk lifestyles for each of the fund participants.

25. A system as defined in claim 23, additionally comprising:
a data verification processor that verifies at least some of the data regarding the fund participants that is statistically pertinent to the longevity of the fund participants.

26. A system as defined in claim 22, wherein information is obtained from each fund participant either as to the level of risk that that fund participant is willing to accept in the financial investments of that fund participant or the particular investments that that fund participant desires to make in the financial investments of that fund participant, and such information is used by the investment management processor to invest and manage the financial investments of that fund participant.

27. A system as defined in claim 22, additionally comprising:
a projected redemption calculation processor that calculates the amount of the periodic redemption payments to each fund participant based upon that fund participant's financial investment, the projected longevity of that fund participant, the projected or actual investment performance for investments made for that fund participant, and a cost of managing the longevity retirement protection fund for that applicant.

28. A system as defined in claim 22, additionally comprising:
a periodic redemption recalculation processor that recalculates the amount of the periodic redemption payments to be made to each fund participant at the end of a defined period occurring less frequently than the frequency of the periodic redemption payments by adding the investment gains for that fund participant of that defined period to the amount in the longevity retirement protection fund for that fund participant at the beginning of a defined period, and subtracting the periodic redemption payments made to that fund participant during that defined period as well as costs of operating the longevity retirement protection fund to produce an end of period longevity retirement protection fund value for that participant, and subsequently calculates the periodic redemption payments to be made to that fund participant during the upcoming defined period based upon that fund participant's projected longevity and estimates for investment gains for that fund participant of an upcoming defined period and costs of operating the longevity retirement protection fund during the upcoming period.

29. A system as defined in claim 22, wherein the periodic redemption payments are made monthly and the defined period is annually.

30. A system as defined in claim 22, additionally comprising:
a projected redemption calculation processor that periodically recalculates the amount of the periodic redemption payments to each fund participant by comparing actual mortality experiences for all fund participants with an estimated mortality experience assumption for all fund participants, developing a revised estimated mortality experience assumption, and determining a modified projected longevity for each fund participant.

31. A system as defined in claim 22, additionally comprising:
a projected redemption calculation processor that periodically compares investment income for each fund participant to an expected investment income for that fund participant, whereupon:
if the investment income for that fund participant is greater than expected, either a. causing the redemption payment processor to pay an excess with the next periodic redemption payment for that fund participant, or b. rolling over the excess into that fund participant's financial investment to increase it (and thus to increase that fund participant's future periodic redemption payments), or c. causing the redemption payment processor to pay the excess to that fund participant in equal amounts in each of a plurality of that fund participant's next periodic redemption payments, or d. causing the redemption payment processor to pay the excess to that fund participant in equal amounts in all of that fund participant's next periodic redemption payments in the period until a next investment income comparison;
if the investment income for that fund participant is less than expected but sufficient for future periodic redemption payments to that fund participant, causing the redemption payment processor to reduce the next periodic redemption payments for that fund participant by the amount of the shortfall; and
if the investment income for that fund participant is less than expected and insufficient for at least one future periodic redemption payment to that fund participant, causing the redemption payment processor to either reduce a plurality of the next several future periodic redemption payments to that fund participant in equal amounts to make up the shortfall, or reduce all of that fund participant's next periodic redemption payments in the period until a next investment income comparison in equal amounts to make up the shortfall.

32. A system as defined in claim 22, additionally comprising:
a withdrawal payment processor that upon receiving a request from a fund participant to terminate participation in the longevity retirement protection fund, determines the value of that fund participant's remaining funds in the longevity retirement protection fund at the time of the termination request, causes the projected longevity processor to determine a revised projected longevity for that fund participant, determines the net present value of future periodic redemption payments for that fund participant for the revised projected longevity for that fund participant, and determines the lesser of the value of that fund participant's remaining funds in the longevity retirement protection fund at the time of the termination request and the net present value of future periodic redemption payments for that fund participant for the revised projected longevity for that fund participant as the termination payment for that fund participant.

33. A system as defined in claim 32, wherein the termination payment for that fund participant is reduced by the expenses incurred in processing the termination request, including the costs of the medical examination.

34. A system as defined in claim 22, additionally comprising:
a withdrawal payment processor that upon receiving a request from a fund participant to terminate participation in the longevity retirement protection fund, optionally determines the value of that fund participant's remaining funds in the longevity retirement protection fund at the time of the termination request, causes the projected longevity processor to determine a revised projected longevity for that fund participant, determines the net present value of future periodic redemption payments for that fund participant for the revised projected longevity for that fund participant, and determines a termination payment for that fund participant based at least in part on the net present value of future periodic redemption payments for that fund participant for the revised projected longevity for that fund participant.
